(19) United States
(12) Patent Application Publication
(10) Pub. No.: US 2018/0104564 A1
(43) Pub. Date: Apr. 19, 2018

(54) EXERCISE APPARATUS

(71) Applicants: Christian Taylor Cardon, Patchogue, NY (US); John Aikens, Patchogue, NY (US)

(72) Inventors: Christian Taylor Cardon, Patchogue, NY (US); John Aikens, Patchogue, NY (US)

(21) Appl. No.: 15/783,085

(22) Filed: Oct. 13, 2017

Related U.S. Application Data
(60) Provisional application No. 62/408,028, filed on Oct. 13, 2016.

(51) Int. Cl. A63B 71/06; A63B 22/02; A63B 22/06; A63B 24/00; A63F 13/85; A63F 13/803; A63F 13/245; A63B 21/00; A63F 13/92

(52) U.S. Cl. CPC A63B 71/0622; A63B 22/025; A63B 22/0605; A63B 24/0087; A63F 13/85; A63F 13/803; A63B 2225/50; A63B 21/4034; A63F 13/92; A63B 2022/0652; A63B 2024/0096; A63B 2071/0625; A63B 2071/0658; A63F 13/245

(57) ABSTRACT

An improved exercise apparatus is a stationary bicycle or a treadmill with an attached video screen and controllers that enable the user to exercise while engaging in the playing of video games or other entertainment activities that utilize a video screen and controllers.

### CROSS-REFERENCE TO RELATED APPLICATION

The present application is related to and claims priority from prior provisional application Ser. No. 62/408,028, filed Oct. 13, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of exercise equipment and more specifically relates to an improved exercise apparatus, that would combine the benefits of exercise with the enjoyment and competition of video games, or various other activities offering consumers a combination of fun and fitness that would get them off the couch and onto the treadmill or bike with pleasure, and a lot more often.

### 2. Description of the Related Art

This country has moved from an industrial society to an information based society, consider, for example, the clear need that millions of Americans have for more exercise and better fitness, the benefits of which include everything from a better mental and emotional attitude, to better sleep, to having more energy and a more attractive physical appearance, higher resistance to stress and illness, and a longer and happier life. With the change of national product, the pace of information and services has increased rapidly adding to many conveniences, but with that there have been changes in American family life. A worker may not work just eight hours in a regular schedule and then go home without having to be concerned with the job anymore. In this information based society, many workers may work odd schedules or long hours with work shifts broken or split. Another side effect of this type of society is a much larger portion of society now lives a sedentary life-style. While sales of exercise equipment remains steady, a growing portion of the population does not get regular exercise. Much of this is due to work schedules and the lack of physical exertion on the job, and probably the largest contributor is that it takes a disproportionate amount of time each day working in order to make ends meet. A solution that could combine exercise with recreation is needed.

Various attempts have been made to solve the above-mentioned problems such as those found in U.S. Pat. No. 4,512,567 to Robert V. Phillips; U.S. Publication No. 2006/0223634 to Philip Feldman; U.S. Pat. No. 6,283,896 to Sarah Grunfeld. This art is representative of exercise equipment. None of the above inventions and patents, taken either singly or in combination, is seen to describe the invention as claimed.

Ideally, exercise equipment should provide higher frequency of use through the combination of exercise and recreation, and yet, would operate reliably and be manufactured at a modest expense. Thus, a need exists for a reliable improved exercise apparatus to avoid the above-mentioned problems.

### BRIEF SUMMARY OF THE INVENTION

In view of the foregoing disadvantages inherent in the known exercise equipment art, the present invention provides a novel improved exercise apparatus. The general purpose of the present invention, which will be described subsequently in greater detail, is to provide exercise and recreation.

The improved exercise apparatus preferably comprises a main frame including a base portion adapted to be placed upon a supporting surface, a vertical support member attached to the base portion that extends vertically upwards therefrom, a rotational member attached to the base portion that is adapted to be rotated by an extremity of a user when in use during exercise, a motor member attached to the base portion and mechanically attached to the rotational member that is adapted to controllably resist movement of the rotational member and to controllably assist movement of the rotational member, a control panel including a main body forming an interior volume, a main screen located on an outer surface of the main body and is adapted to face toward and be accessible by the user, a computer member located within the interior volume that is electrically connected to the main screen, a plurality of control members located upon the main screen that are electrically connected to the computer member and are adapted to allow the user to control the computer member.

The control panel is attached to an upper portion of the vertical support member and adapted to be accessible by the user for controlling the motor member and thereby the rotational member for choosing between a plurality of exercise modes. At least one control member including a main arm portion is adapted to be removably connected to the vertical support member of the main frame and extend outwardly therefrom.

A handle portion is attached to the distal end of the arm portion and is adapted to be accessible by an extremity of the user. At least one button member is connected to the handle portion and is adapted to send an electronic signal to the computer member of the control panel. The control member is adapted to allow the user to control the control panel while using the improved exercise apparatus.

A power source is electrically connected to the motor member, the control panel, and the control member to thereby provide electric power thereto. A second rotational member is rotationally attached to the base portion and is spaced from the rotational member of the base portion. A belt member is connected between the rotational member and the second rotational member to support the user thereon and when the motor is activated by the control panel the rotational member rotates the belt member and thereby the second rotational member such that the user can walk or run upon the belt member for exercising. The motor member is adapted to controllably assist movement of the rotational member as the user is walking or running upon the belt member.

A seat support member is attached to the base portion of the main frame and extends vertically upwards therefrom and is attached to the distal end of the seat post member and is adapted to support the user thereon during exercise. A left pedal member is attached to the left end of the rotational member and a right pedal member is attached to a right end of the rotational member. The user can sit upon the seat member and place their feet respectively upon the left and right pedal members and rotate the rotational member for exercising. The motor member is adapted to controllably resist movement of the rotational member during the exercising.

A remote hand-held controller includes at least one button member adapted to send an electronic signal to the computer member of the control panel that adapted to allow the user to control the control panel while using the improved exercise apparatus. The control panel is formed as a touch screen display member. The plurality of control buttons are formed as computer icons displayed upon the touch screen display member via the computer member. The computer member of the control panel includes software thereon adapted to provide the user with computer games to play via the main screen while exercising. The control member is adapted to be used to play the computer games while exercising.

The handle portion of the control member is rotatably attached to the distal end of the arm portion such that the user can use the handle portion as a steering wheel for a driving computer game. The motor member may be formed as an electric motor. The power source may be formed as an electric power cord adapted to be connected with an external power source. The plurality of exercise modes includes variable speeds of the rotational member. The vertical support member of the main frame includes at least one speaker member that is electrically connected to the computer member of the control panel and is adapted to emit audio sounds for the user to hear during exercise.

The vertical support member of the main frame may include a headphone jack electrically connected to the computer member of the control panel and a headphone member adapted to be removably plugged into the headphone jack and adapted to emit audio sounds for the user to hear during exercise. The control panel further includes a computer card reader electrically connected to the computer member and adapted to read a computer card adapted to retain exercise information thereon. A computer card is adapted to retain exercise information thereon and adapted such that the computer card can be inserted into the computer card reader and information thereon retrieved by the computer member and used by the user. The seat member may include a gel material adapted to provide comfort for a user sitting thereon.

The touchscreen display member may be formed as a liquid crystal display member. The computer member further includes software adapted to allow other computer applications to be programmed thereon. The other computer applications are chosen from a list of computer applications consisting of itunes, Netflix, Hulu, The Nook, Kindle, Zombie Run, Temple Run, Outdoor Trail Run, Solitaire, and Tetris. There may be two control members spaced from one another upon the vertical support member that are adapted to be held by respective left and right hands of the user during exercise.

Treadmill, like other premium-quality treadmills, would be electrically powered, variable-speed, programmable, and motorized, relying on a belt which moves in a continuous loop by motor-driven rollers. Likewise, stationary bike exercise bike would feature an adjustable gel seat with an adjustable seat-back, strong alloy frame and ergonomically designed, adjustable resistance pedals. Both products would offer the user a choice of programs—hill climbing or inclines, fat-burning, caloric output monitor, heart-rate control, time and distance monitor, that will be recorded on a (optional) cac card inserted into the machine during use to help users keep track of their progress throughout their workout regimen or by logging onto the user account from the home screen. Both the treadmill and stationary bike would feature extra-large (20″×15″) lcd touchscreen with privacy screen displays for gaming, and for setting the various programs and monitoring one's progress during use such as, heart-rate, distance, and speed (also recorded on a cac card or users account) as well as a webcam for the users on business trips to stay in touch with family and not having to give up working out with their busy schedule. The touchscreens and controls with which improved exercise apparatus would be equipped, however, would enable the user not simply to exercise, but to exercise while interactively playing video games, listening to music from itunes, or other music apps; watching movies or TV shows on NETFLIX, or HULU, etc.; or reading a book from the NOOK, or AMAZON KINDLE apps; or experience a ZOMBIE RUN, TEMPLE RUN, OUTDOOR TRAIL RUN; or relax and enjoy some old time favorite games such as SOLITAIRE, TETRIS, MARIO KART etc. Common apps used today will be available as default on all machines, home models will feature app customization where the user will be able to download and apply all the apps him/her would want. Variable speed settings of “Easy” (0 to 4 mph): “Intermediate” (0 to 6 mph): “Hard” (0 to 8 mph): and “Expert” (0 to the runner's highest capability) would be offered. Treadmill 190 would be controlled either through pressing icons on the touchscreen, or through the set of integrated remotes. These remotes, which can serve to set the speed of the treadmill and it's other variables, also serve as hand-held controllers which are attached via retractable braded cables for video games played, or other various apps and programs listed above, controllers that the user can hold comfortably in each hand, while maintaining his or her arm and hand motion while walking, jogging, or running Stationary bike would feature an adjustable steering wheel (up and down) incorporating functional-buttons that make it a controller for road-racing video games, or various apps and programs listed above. Both treadmill 190 and exercise bike would be equipped with Wi-Fi, BLUETOOTH, and Wireless HDMI, permitting users to stream games to improved exercise apparatus from their PC's, gaming consoles, or the internet, as well as compete against other improved exercise apparatus users in an online versus/tournament mode, which each user will be matched based on difficulty selected. To avoid use of only user sitting on exercise machine not working out, the screen will time out after two minutes should the user stop moving/pedaling on the machine. A message will then prompt the individual with a “one minute count down” to select the continue, or stop and save option. Internet surfing will be available for home models for the user to be able to shop online, read articles, check social media, etc. But will not be included on public models due to security. Home models will be customizable in texture and color, and feature high quality speakers which the user can use instead of headphones.

The present invention holds significant improvements and serves as an improved exercise apparatus. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved exercise apparatus constructed and operative according to the teachings of the present invention.

FIG. 1 shows a perspective view of an in-use condition illustrating an improved exercise apparatus according to an embodiment of the present invention.

FIG. 2 is a side view illustrating the improved exercise apparatus according to an embodiment of the present invention of FIG. 1.

FIG. 3 is a front view illustrating a handle portion of the improved exercise apparatus according to an embodiment of the present invention of FIG. 1.

FIG. 4 is a perspective view illustrating an alternate embodiment of the improved exercise apparatus according to an embodiment of the present invention of FIG. 1.

FIGS. 5A-5C are screen shots illustrating the software of the improved exercise apparatus according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relates to exercise equipment and more particularly to an improved exercise apparatus as used to improve the frequency of use through the combination of exercise and recreation.

Generally speaking, an improved exercise apparatus is a stationary bicycle or a treadmill with an attached video screen and controllers that enable the user to exercise while engaging in the playing of video games or other entertainment activities that utilize a video screen and controllers.

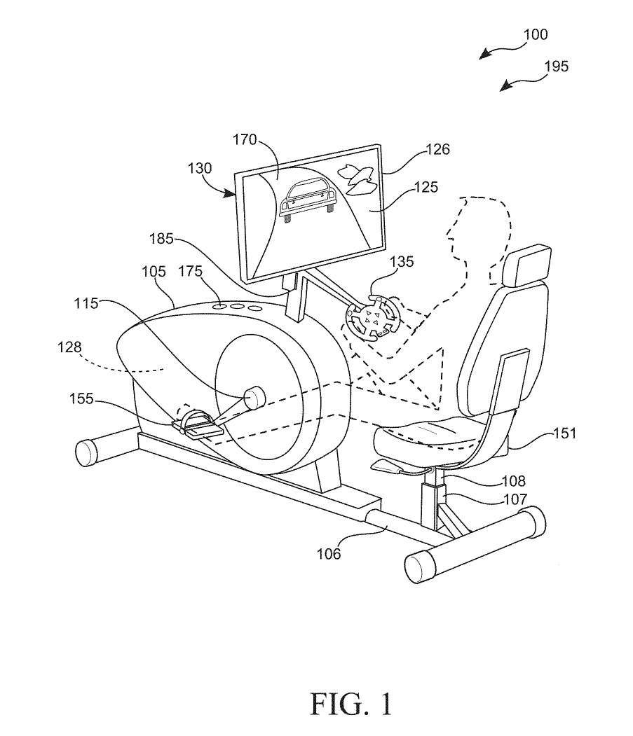

Referring to the drawings by numerals of reference there is shown in FIG. 1, a perspective view of an in-use condition illustrating improved exercise apparatus 100 according to an embodiment of the present invention.

Improved exercise apparatus 100 is an exercise treadmill 190 or stationary bike 195 that would combine the benefits of exercise with the enjoyment and competition of video games or various other activities providing users a combination of recreation and fitness that would provide them with the exercise of treadmill 190 or stationary bike 195 increasing probable frequency of exercise. Improved exercise apparatus 100 would be electrically powered, variable-speed, programmable, and motorized, relying on belt member 110 on treadmill 190 embodiments, which moves in a continuous loop by motor member 120 driven rotational member 115. Likewise, improved exercise apparatus 100 stationary bike 195 would have an adjustable gel seat member 151 with an adjustable seat-back, strong alloy main frame 105 and ergonomically designed, adjustable resistance pedal member 157 motion.

Motor member 120 may be formed as electric motor 121. Power source 145 may be formed as electric power cord 146 adapted to be connected with external power source 147. The plurality of exercise modes includes variable speeds of rotational member 115. Vertical support member 107 of main frame 105 includes at least one speaker member 175 that is electrically connected to computer member 130 of control panel 125 and is adapted to emit audio sounds for the user to hear during exercise.

Vertical support member 107 of main frame 105 may include headphone jack 180 electrically connected to computer member 130 of control panel 125 and headphone member 176 adapted to be removably plugged into headphone jack 180 and adapted to emit audio sounds for the user to hear during exercise. Control panel 125 further includes computer card reader 185 electrically connected to computer member 130 and adapted to read a computer card 186 adapted to retain exercise information thereon. Computer card 186 is adapted to retain exercise information thereon and adapted such that computer card 186 can be inserted into computer card reader 185 and information thereon retrieved by computer member 130 and used by the user. Seat member 151 may include a gel material adapted to provide comfort for a user sitting thereon.

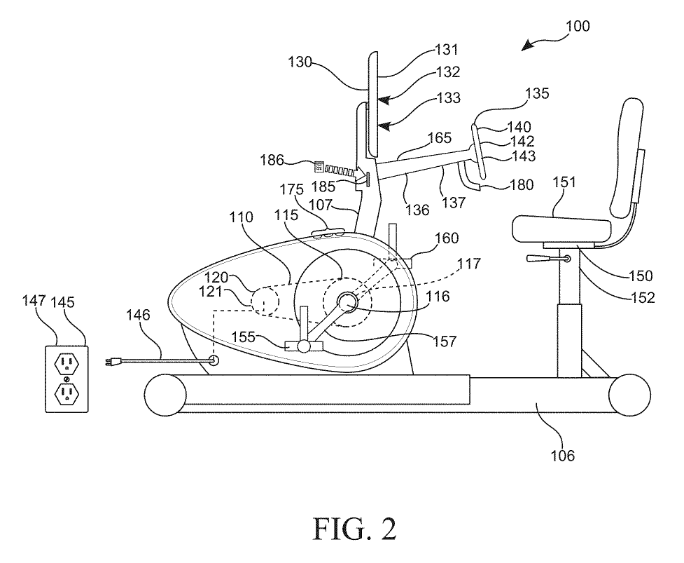

Referring now to FIG. 2, is a side view illustrating improved exercise apparatus 100 according to an embodiment of the present invention of FIG. 1.

Improved exercise apparatus 100 preferably comprises main frame 105 including base portion 106 adapted to be placed upon a supporting surface, vertical support member 107 attached to base portion 106 that extends vertically upwards therefrom, rotational member 115 attached to base portion 106 that is adapted to be rotated by an extremity of a user when in use during exercise, motor member 120 attached to base portion 106 and mechanically attached to rotational member 115 that is adapted to controllably resist movement of rotational member 115 and to controllably assist movement of rotational member 115, control panel 125 including main body 126 forming interior volume 128, main screen 127 located on an outer surface of main body 126 and is adapted to face toward and be accessible by the user, computer member 130 located within interior volume 128 that is electrically connected to main screen 127, a plurality of control members 131 located upon main screen 127 that are electrically connected to computer member 130 and are adapted to allow the user to control computer member 130.

Seat support member 150 is attached to base portion 106 of main frame 105 and extends vertically upwards therefrom and is attached to distal end 152 of seat support member 150 and is adapted to support the user thereon during exercise. Left pedal member 155 is attached to left end 116 of rotational member 115 and right pedal member 160 is attached to right end 117 of rotational member 115. The user can sit upon seat member 151 and place their feet respectively upon the left 157 and right pedal members 160 and rotate rotational member 115 for exercising. Motor member 120 is adapted to controllably resist movement of rotational member 115 during the exercising.

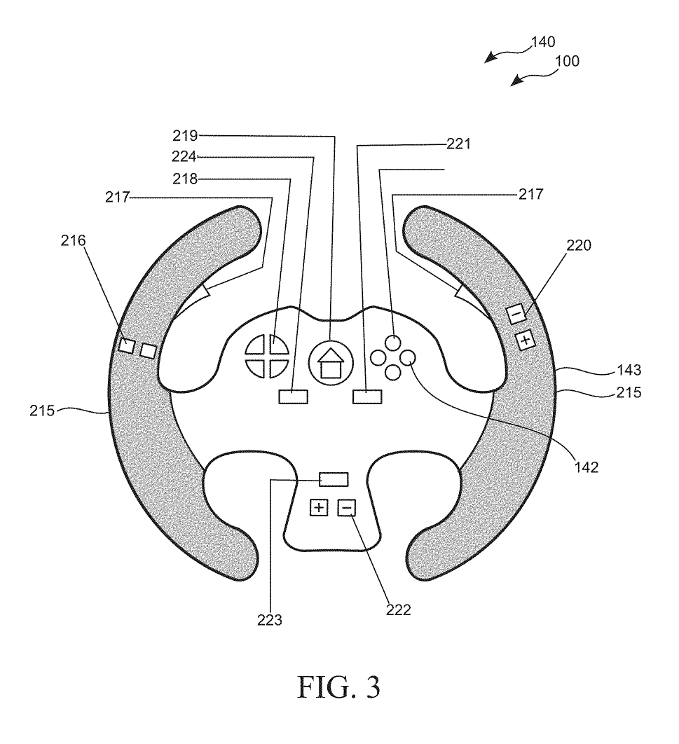

Referring now to FIG. 3, is a front view illustrating handle portion 140 of improved exercise apparatus 100 according to an embodiment of the present invention of FIG. 1.

Control panel 125 is attached to upper portion 108 of vertical support member 107 and adapted to be accessible by the user for controlling motor member 120 and thereby rotational member 115 for choosing between a plurality of exercise modes. At least one control member 135 including a main arm portion 136 is adapted to be removably connected to vertical support member 107 of main frame 105 and extend outwardly therefrom. Handle portion 140 of control member 135 is rotatably attached to distal end 137 of arm portion 136 such that the user can use handle portion 140 as steering wheel 143 for a driving computer game. Remote hand-held controller 165 includes at least one button member 166 adapted to send an electronic signal to computer member 130 of control panel 125 that is adapted to allow the user to control control panel 125 while using improved exercise apparatus 100. Control panel 125 is formed as touchscreen display member 170. The plurality of control members 131 are formed as computer icons displayed upon touchscreen display member 170 via computer member 130. Computer member 130 of control panel 125 includes software 132 thereon adapted to provide the user with computer game(s) 133 to play via main screen 127 while exercising. Control members 131 is adapted to be used to play computer game(s) 133 while exercising.

Touchscreen display member 170 may be formed as a liquid crystal display member. Computer member 130 further includes software 132 adapted to allow other computer applications to be programmed thereon. The other computer applications are chosen from a list of computer applications consisting of itunes, netflix, hulu, the nook, kindle, zombie run, temple run, outdoor trail run, solitaire, and tetris. There may be two computer member 130 spaced from one another upon vertical support member 107 that are adapted to be held by respective left and right hands of the user during exercise.

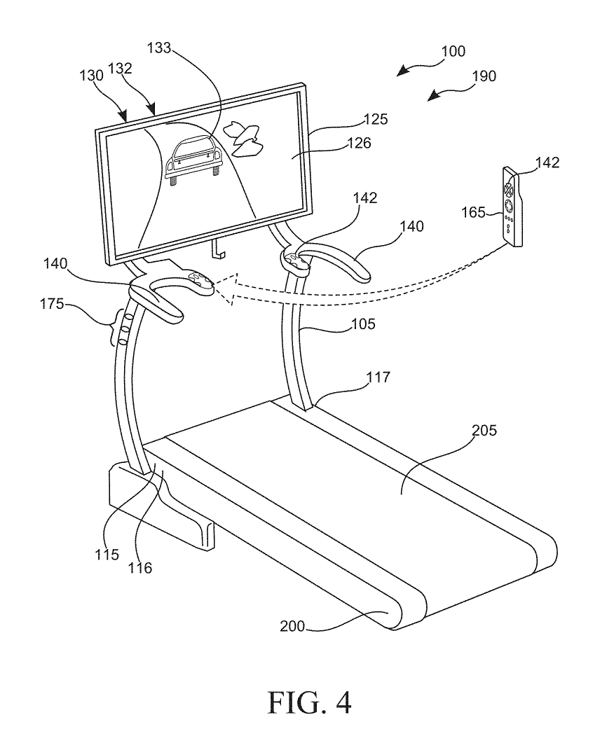

Referring now to FIG. 4, showing a perspective view illustrating an alternate embodiment of improved exercise apparatus 100 according to an embodiment of the present invention of FIG. 1.

In a second embodiment, improved exercise apparatus 100 may be formed as treadmill 190. In this embodiment, handle portion 140 is attached to distal end 137 of arm portion 136 and is adapted to be accessible by an extremity of the user. At least one button member 166 is connected to handle portion 140 and is adapted to send an electronic signal to computer member 130 of control panel 125. Control members 131 are adapted to allow the user to operate control panel 125 while using improved exercise apparatus 100.

Power source 145 is electrically connected to motor member 120, control panel 125, and control members 131 to thereby provide electric power thereto. Second rotational member 200 is rotationally attached to base portion 106 and is spaced from rotational member 115 of base portion 106. Belt member 110 is connected between rotational member 115 and second rotational member 200 to support the user thereon and when motor member 120 is activated by control panel 125, rotational member 115 rotates belt member 205 and thereby second rotational member 200 such that the user can walk or run upon belt member 205 for exercising. Motor member 120 is adapted to controllably assist movement of rotational member 115 as the user is walking or running upon belt member 205.

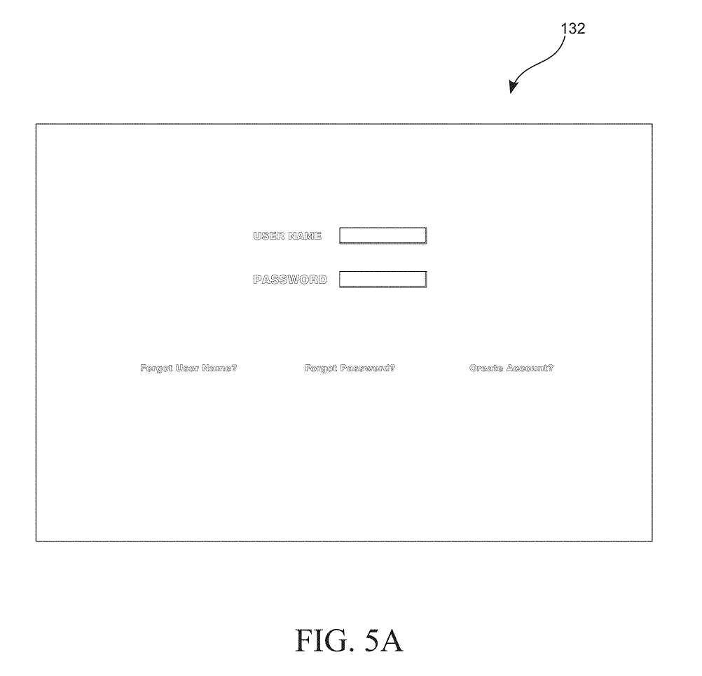

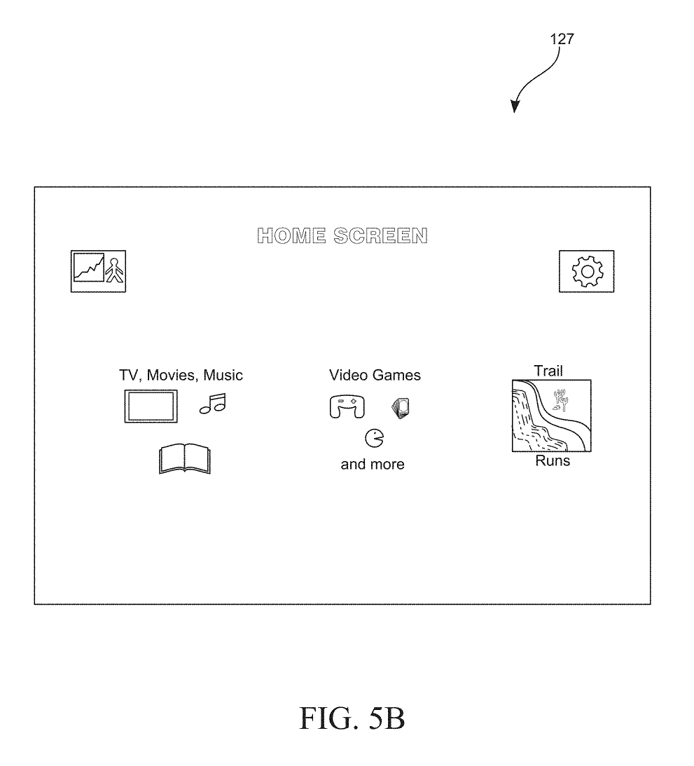

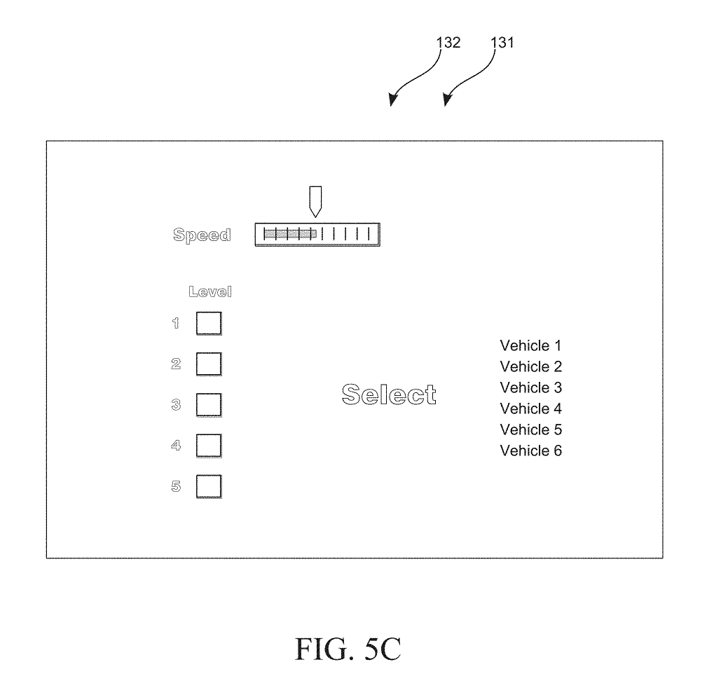

FIGS. 5A-5C are screen shots illustrating software 132 of the improved exercise apparatus according to an embodiment of the present invention.

Software 132 loaded onto computer member 130 that may be installed on improved exercise apparatus 100 may vary from embodiment to embodiment, and may further be re-programmable with administrative level authority. Computer game(s) 133 may be deleted and new computer game(s) 133 added as well as reconfiguring control members 131 to enhance user convenience or preference.

When unit is being utilized, user will come to Log-in Screen where they will log on via username and password or with their computer card 186 which would be inserted into computer card reader 185. Screens will have a protective layer so as to be privately viewed only from the user's point of view to keep passwords, security questions and progress (weight, calories) safe from wondering eyes.

Forgot password or username: user can select this option on treadmill 190 or stationary bike 195, where they will be asked a security question associated with their account. Once completed, the user can receive a text or email with temporary code until password is reset (in their own time) and/or the gym he or she is associated with can retrieve their current password or username via a REV-X website and will need to verify their identity with a driver's license in order to gain access to private information. If the user has computer card 186 this step would be eliminated due to the secure chip on the card.

Create Account: user can select this option if user is new to get started with the stationary bike 195 or treadmill 190. Once registration is complete user will have their data saved to server, so that they can log in when revisiting the same equipment.

Help Button: shows user helpful information about either the treadmill 190 or stationary bike 195, examples being: where to purchase computer card 186, how to navigate menus, customer support for account etc.

Settings Button: user can use this button to select screen saver from screen savers pre-loaded on gym models and can also customize weather information on home models, etc.

Log-in Screen: When unit is being utilized, user will come to Log-in Screen where they will log on via username and password or with computer card 186 which would be inserted into improved exercise apparatus 100. Touchscreen display member 170 will have a protective layer so as to be privately viewed only from the user's point of view to keep passwords, security questions and progress (weight, calories) safe from wondering eyes.

Forgot password or username: user can select this option on improved exercise apparatus 100, where they will be asked a security question associated with their account. Once completed, the user can receive a text or email with temporary code until password is reset (in their own time) and/or the gym he or she is associated with can retrieve their current password or username via a REV-X website and will need to verify their identity with a driver's license in order to gain access to private information. If the user has computer card 186 this step would be eliminated due to the secure chip on computer card 186.

Create Account: user can select this option if user is new to get started with improved exercise apparatus 100. Once registration is complete user will have their data saved to server, so that they can log in when revisiting improved exercise apparatus 100.

Help Button: shows user helpful information about either improved exercise apparatus 100 examples being: where to purchase computer card 186, how to navigate menus, customer support for account etc.

Settings Button: user can use this button to select screen saver for improved exercise apparatus 100 from screen savers pre-loaded on gym models and can also customize weather information on home models, etc.

Home Screen: Once user has logged in securely, they will come to this screen sharing three icons with the following genres:

T.V., Movies, Music and Literature, Video Games and More, and additionally Trail Runs, with each featuring numerous apps in conjuncture with that genre/cluster of genres. This will allow user to have access to their account associated with app(s) so they may view shows via NETFLIX/HULU/HBO, or listen to ITUNES/SPOTIFY/PANDORA or music app of choice, read books of choice on KINDLE/AUDIBLE, etc. Games can also be selected from the apps with choices varying but not limited to: SOLITAIRE, TETRIS, PAC MAN, MARIO CART, FORZA, etc. Users will also have the ability to link up with one another to compete in a race or any other two player challenge games.

Pull tabs will be available to select on this screen. Right pull tab will feature viewable setting option icons, account info icons, help icon, etc. The left tab will display exercise data such as: speed, incline, heart rate provided by synching with apps such as FITBIT or MIOFUSE (if user has these devices available) along with their pre-set goals with progress statistics as well. If user does not have these devices available to them, then only their goals will display (progress they've made, how much longer till they reach them if continual progress is made), as well as progress statistics provided to them to help stay focused on a diligent path to a healthy lifestyle. FITBIT and MIOFUSE or other devices can be synced with treadmill 190 or stationary bike 195 to allow user to conveniently track their heart rate, calories burned, steps taken, distance etc. All apps have the ability to be minimized when there is more than one app in use. Split screen to work with two apps at one time will also be available. Home models will have customizable Home Screens allowing users to download their favorite apps or programs they already use.

Home models will allow free roaming internet access so user may update social media while working out, shop for groceries, buy wants and needs on AMAZON/EBAY/TARGET and engage in business calls via SKYPE or CISCO.

Log-In Screen:

When unit is being utilized, user will come to Log-in Screen where they will log on via username and password or with their CAC Card which would be inserted into the machine. Screens will have a protective layer so as to be privately viewed only from the user's point of view to keep passwords, security questions and progress (weight, calories) safe from wondering eyes.

Forgot password or username: user can select this option on the treadmill/bike, where they will be asked a security question associated with their account. Once completed, the user can receive a text or email with temporary code until password is reset (in their own time) and/or the gym he or she is associated with can retrieve their current password or username via a Rev-X website and will need to verify their identity with a driver's license in order to gain access to private information. If the user has a CAC Card this step would be eliminated due to the secure chip on the card.

Create Account: user can select this option if user is new to get started with the bike or treadmill. Once registration is complete user will have their data saved to server, so that they can log in when revisiting bike or treadmill.

Help Button: shows user helpful information about either the treadmill/bike examples being: where to purchase CAC Card, how to navigate menus, customer support for account etc.

Settings Button: user can use this button to select screen saver for treadmill/bike from screen savers pre-loaded on gym models and can also customize weather information on home models, etc.

Home Screen: Once user has logged in securely, they will come to this screen sharing three icons with the following genres:

T.V., Movies, Music and Literature, 2. Video Games and More and lastly 3. Trail Runs, with each featuring numerous apps in conjuncture with that genre/cluster of genres. This will allow him or her to have access to their account associated with app(s) so they may catch up on shows via NETFLIX/HULU/HBO, get in the zone with their ITUNES/SPOTIFY/PANDORA music app of choice, lose themselves in their books of choice on KINDLE/AUDIBLE, etc. Games can also be selected from the apps with choices varying but not limited to: SOLITAIRE, TETRIS, PAC MAN, MARIO CART, FORZA, etc. Users will also have the ability to link up with one another to compete in a race or any other two player challenge games.

Pull tabs will be available to select on this screen. Right pull tab will feature viewable setting option icons, account info icons, help icon, etc. The left tab will display exercise data such as: speed, incline, heart rate provided by synching with apps such as FITBIT or MIOFUSE (if user has these devices available) along with their pre-set goals with progress statistics as well. If user does not have these devices available to them, then only their goals will display (progress they've made, how much longer till they reach them if continual progress is made), as well as progress statistics provided to them to help stay focused on a diligent path to a healthy lifestyle.

FITBIT and MIOFUSE or other devices can be synced with treadmill system or bike to allow user to conveniently track their heart rate, calories burned, steps taken, distance etc.

All apps have the ability to be minimized when there is more than one app in use. Split screen to work with two apps at one time will also be available.

Home models will have customizable Home Screens allowing users to download their favorite apps or programs they already use.

Home models will allow free roaming internet access so user may update social media while working out, shop for groceries, buy wants and needs on AMAZON/EBAY/TARGET and engage in business calls via SKYPE/CISCO.

In a preferred embodiment, as shown in FIG. 3, steering wheel 143 includes the following button members 142 and features: comfort hand grips 215; music selection buttons 216; triggers 217; directional pad 218; home button 219; pedal resistance adjustment buttons 220; game menu button 221; volume controls 222; internet connection indicator 223; and steering wheel 143 is preferably an adjustable height steering wheel 143. The exact configuration, number, shape, and function of the buttons may vary from embodiment to embodiment.

Improved exercise apparatus 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved exercise apparatus comprising:
a main frame including:
a base portion;
wherein said base portion is adapted to be placed upon a supporting surface;
a vertical support member;
wherein said vertical support member is attached to said base portion and extends vertically upwards therefrom;
a rotational member;
wherein said rotational member is rotationally attached to said base portion and is adapted to be rotated by an extremity of a user when in use during exercise;
a motor member;
wherein said motor member is attached to said base portion and mechanically attached to said rotational member;
wherein said motor member is adapted to controllably resist movement of said rotational member; and
wherein said motor member is adapted to controllably assist movement of said rotational member;
a control panel including:
a main body;
wherein said main body forms an interior volume;
a main screen;
wherein said main screen is located on an outer surface of said main body and is adapted to face toward and be accessible by said user;
a computer member;
wherein said computer member is located within said interior volume and is electrically connected to said main screen;
a plurality of control members;
wherein said plurality of control members are located upon said main screen, are electrically connected to said computer member, and are adapted to allow said user to control said computer member;
wherein said control panel is attached to an upper portion of said vertical support member and adapted to be accessible by said user for controlling said motor member and thereby said rotational member for choosing between a plurality of exercise modes;
at least one control member including:
an arm portion;
wherein said arm portion is adapted to be removably connected to said vertical support member of said main frame and extend outwardly therefrom;
a handle portion;
wherein said handle portion is attached to a distal end of said arm portion and is adapted to be accessible by an extremity of said user;
at least one button member;
wherein each of said at least one button member are connected to said handle portion and are adapted to send an electronic signal to said computer member of said control panel;
wherein said control member is adapted allow said user to control said control panel while using said improved exercise apparatus; and
a power source;
wherein said power source is electrically connected to said motor member, said control panel, and control member to thereby provide electric power thereto.

2. The improved exercise apparatus of claim 1, further comprising:
a second rotational member;
wherein said second rotational member is rotationally attached to said base portion and is spaced from said rotational member of said base portion; and
a belt member;
wherein said belt member is connected between said rotational member and said second rotational member;
wherein said belt member is adapted to support said user thereon and when said motor is activated by said control panel said rotational member rotates said belt member and thereby said second rotational member such that said user can walk or run upon said belt member for exercising; and
wherein said motor member is adapted to controllably assist movement of said rotational member as said user is walking or running upon said belt member.

3. The improved exercise apparatus of claim 1, further comprising:
a seat support member;
wherein said seat support member is attached to said base portion of said main frame and extends vertically upwards therefrom; and
a seat member;
wherein said seat member is attached to a distal end of said seat post member and is adapted to support said user thereon during exercise;
a left pedal member;
wherein said left pedal member is attached to a left end of said rotational member; and
a right pedal member;
wherein said right pedal member is attached to a right end of said rotational member;
wherein said user can sit upon said seat member and place their feet respectively upon said left and right pedal members and rotate said rotational member for exercising; and
wherein said motor member is adapted to controllably resist movement of said rotational member during said exercising.

4. The improved exercise apparatus of claim 1, further comprising a remote hand-held controller including at least one button member adapted to send an electronic signal to said computer member of said control panel and adapted to allow said user to control said control panel while using said improved exercise apparatus.

6. The improved exercise apparatus of claim 1, wherein said control panel is formed as a touchscreen display member; and wherein said plurality of control buttons are formed as computer icons displayed upon said touchscreen display member via said computer member.

7. The improved exercise apparatus of claim 1, wherein said computer member of said control panel includes software thereon adapted to provide said user with computer games, such that said user can play computer games via said main screen while exercising.

8. The improved exercise apparatus of claim 7, wherein said at least one control member is adapted to be used to play said computer games while exercising.

9. The improved exercise apparatus of claim 8, wherein said handle portion of said at least one control member is rotatably attached to said distal end of said arm portion, such that said user can use said handle portion as a steering wheel for a driving computer game.

10. The improved exercise apparatus of claim 1, wherein said motor member is formed as an electric motor.

11. The improved exercise apparatus of claim 1, wherein said power source is formed as an electric power cord adapted to be connected with an external power source.

12. The improved exercise apparatus of claim 1, wherein said plurality of exercise modes includes variable speeds of said rotational member.

13. The improved exercise apparatus of claim 1, wherein said vertical support member of said main frame includes at least one speaker member is electrically connected to said computer member of said control panel and is adapted to emit audio sounds for said user to hear during exercise.

14. The improved exercise apparatus of claim 1, wherein said vertical support member of said main frame includes a headphone jack electrically connected to said computer member of said control panel; and a headphone member adapted to be removably plugged into said headphone jack and adapted to emit audio sounds for said user to hear during exercise.

15. The improved exercise apparatus of claim 1, wherein said control panel further includes a computer card reader electrically connected to said computer member and adapted to read a computer card adapted to retain exercise information thereon; and wherein said improved exercise apparatus further comprises a computer card adapted to retain exercise information thereon and adapted such that said computer card can be inserted into said computer card reader and information thereon retrieved by said computer member and used by said user.

16. The improved exercise apparatus of claim 3, wherein said seat member includes a gel material adapted to provide comfort for a user sitting thereon.

17. The improved exercise apparatus of claim 6, wherein said touchscreen display member is formed as a liquid crystal display member.

18. The improved exercise apparatus of claim 1, wherein said computer member further includes software adapted to allow other computer applications to be programmed thereon.

19. The improved exercise apparatus of claim 18, wherein said other computer applications are chosen from a list of computer applications consisting of iTunes, Netflix, Hulu, The Nook, Kindle, Zombie Run, Temple Run, Outdoor Trail Run; Solitaire, and Tetris.

20. The improved exercise apparatus of claim 1, wherein there are two control members spaced from one another upon said vertical support member and adapted to be held by respective left and right hands of said user during exercise.
